(19) United States
(12) Patent Application Publication
(10) Pub. No.: US 2005/0223799 A1
(43) Pub. Date: Oct. 13, 2005

(54) System and method for motion capture and analysis

(76) Inventor: Brian Murphy, Encino, CA (US)

Correspondence Address: FOLEY & LARDNER, 2029 CENTURY PARK EAST, SUITE 3500, LOS ANGELES, CA, 90067, US

(21) Appl. No.: 10/815,237

(22) Filed: Mar. 31, 2004

(51) Int. Cl. G01P 3/56

(52) U.S. Cl. 73/510; 73/866.1; 73/865.4

(57) ABSTRACT

A system and method for capturing and analyzing motion. According to embodiments of the present invention, the system and method may include defining a standard motion; receiving a first signal from a first sensor, the first signal being representative of a motion under analysis; receiving a second signal from a second sensor, the second signal being representative of the motion under analysis; synchronizing the first signal to the second signal; and comparing the motion under analysis represented by the synchronized first signal and second signal to the standard motion. The system may include video cameras and position sensors and may be include a computer. The computer may be networked.

### BACKGROUND OF THE INVENTION

The present invention relates to the field of data acquisition and analysis and in particular, to the capture and analysis of data representing a moving subject such as, for example, an athlete executing an athletic maneuver.

As athletes and others become more and more sophisticated in their training techniques and contest preparation procedures, they have increasingly relied upon motion analysis as a training and preparation tool. A motion analysis system provides a user with the ability to view a particular motion or maneuver in an effort to improve the chances of a successful result for which the motion has been undertaken.

However, many motion analysis systems are lacking in the feedback provided to the user and the manner in which analysis of the motion is performed. For example, many motion analysis systems simply provide the user with a video display of the motion being analyzed synchronized with body position information or provide the user simply with a video display alone of the motion being analyzed. There is currently lacking in the motion analysis area a mechanism by which the motion under analysis may be compared to other motion. In addition, there is currently lacking in the motion analysis area a mechanism by which feedback to the user may be provided that improves the chances of a successful result for which the motion has been undertaken.

### SUMMARY OF THE INVENTION

According to an embodiment of the present invention, a method for capturing and analyzing motion may include defining a standard motion; receiving a first signal from a first sensor, the first signal being representative of a motion under analysis; receiving a second signal from a second sensor, the second signal being representative of the motion under analysis; synchronizing the first signal to the second signal; and comparing the motion under analysis represented by the synchronized first signal and second signal to the standard motion. Comparing the motion under analysis may include identifying when the motion under analysis falls outside of an acceptable range of motion in relation to the standard motion. The method may further include adjusting the motion under analysis based on the comparison of the synchronized first signal and second signal to the standard motion.

According to an embodiment of the present invention, the method may further include logging an intended result of the motion under analysis and adjusting the motion under analysis based on the comparison of the synchronized first signal and second signal to the intended result of the motion under analysis. Also, the method may include initiating a trigger event to begin receiving the first signal or the second signal or to terminate receiving the first signal or the second signal. The method may also include time-stamping the first signal or the second signal.

According to an embodiment of the present invention, the first signal may be a video signal. The second signal may represent position information. The method may also include reconstructing the motion under analysis using the position information and comparing the reconstructed motion to the standard motion. The standard motion may be a generally accepted ideal motion for the motion under analysis or may be an ideal motion for a subject executing the motion under analysis. The standard motion may be defined by a user. Also, the method may include generating a composite display of the first signal and the second signal. The method may include generating a composite display of the video signal and the reconstructed motion under analysis.

According to an embodiment of the present invention, the method may include capturing the video signal with a video camera and focusing the video camera on a subject providing the motion under analysis. The method may also include analyzing the video signal in relation to the position information when the motion under analysis falls outside of the acceptable range of motion. Also, the method may include positioning sensors for capturing the position information on a subject providing the motion under analysis. The sensors may be magnetic sensors or optical sensors.

The method may also include receiving a third signal from a third sensor, the third signal being representative of environmental data; synchronizing the third signal to the first signal and the second signal; and analyzing the motion under analysis represented by the synchronized first signal and second signal in relation to the third signal. The method may also include receiving a fourth signal from a fourth sensor, the fourth signal being representative of a mechanical or electrical parameter; synchronizing the fourth signal to the first signal and the second signal; and analyzing the motion under analysis represented by the synchronized first signal and second signal in relation to the fourth signal. The method may also include providing visual or audio feedback when the motion under analysis falls outside the acceptable range of motion. In addition, the method may include accepting a query from a user when comparing the motion under analysis represented by the synchronized first signal and second signal to the standard motion.

Receiving the first signal and receiving the second signal may include receiving the first signal and the second signal over a network. The network may be the Internet.

According to an embodiment of the present invention, a system for capturing and analyzing motion may include an input device for receiving data defining a standard motion; a first sensing device for generating a first signal representative of a motion under analysis; a second sensing device for generating a second signal representative of the motion under analysis; a synchronizer for synchronizing the first signal to the second signal; and a processor for comparing the motion under analysis represented by the synchronized first signal and second signal to the data defining the standard motion. The input device may receive data representing an intended result of the motion under analysis. The processor may be configured to evaluate the motion under analysis in light of the intended result of the motion under analysis.

The system may also include a first trigger mechanism for initiating generation of the first signal and a second trigger mechanism for initiating generation of the second signal.

Also, the system may include a time-stamper for time-stamping the first signal or for time-stamping the second signal. The first sensing device may be a video camera and the first signal may be a video signal. The second sensing device may be a motion sensor and the second signal may represent position information. The motion sensor may be a magnetic sensor or an optical sensor.

### BRIEF DESCRIPTION OF THE DRAWINGS

A detailed description of embodiments of the invention will be made with reference to the accompanying drawings, wherein like numerals designate corresponding parts in the several figures.

FIG. 1 shows a schematic diagram of a system for motion analysis according to an embodiment of the present invention.

FIG. 2 shows a generalized system diagram for motion capture and analysis according to an embodiment of the present invention.

FIG. 3 shows a simplified flow chart for capturing and analyzing a motion according to an embodiment of the present invention.

FIG. 4 shows a detailed flow chart of a method for capturing and analyzing motion data according to an embodiment of the present invention.

FIG. 5 shows a generalized schematic diagram of a system for motion capture and analysis according to another embodiment of the present invention.

FIG. 6 shows a generalized schematic diagram of a system for motion capture and analysis according to another embodiment of the present invention.

### DETAILED DESCRIPTION OF THE PREFERRED EMBODIMENTS

In the following description of preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the preferred embodiments of the present invention.

Although embodiments of the present invention are explained using athletes engaged in athletic activity, such as, for example, a basketball player taking a shot, embodiments of the present invention could be applied to any sport or to any activity for which the capture and analysis of a subject or an object in motion is desired. For example, embodiments of the present invention may be applied to capturing and analyzing the movements and motions of football players, baseball players, volleyball players, golfers, soccer players, cyclists, track and field athletes and the like. In addition, embodiments of the present invention may be applied to structural, mechanical or electromechanical objects, such as automobiles, motorcycles, bicycles, athletic equipment and the like.

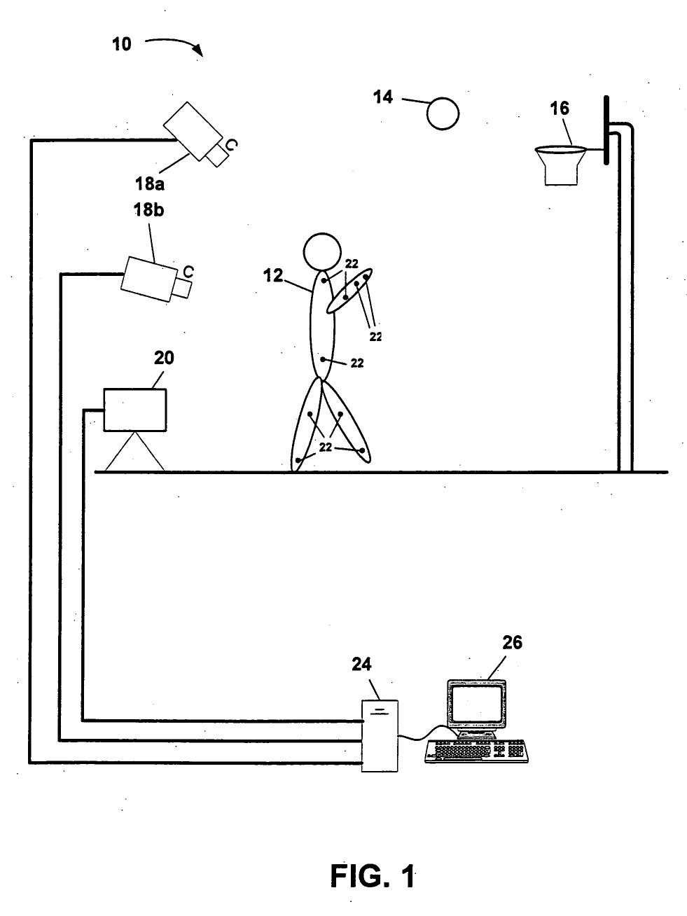

FIG. 1 shows a generalized schematic diagram of a system for motion capture and analysis 10 according to an embodiment of the present invention. In FIG. 1, the system for motion capture and analysis 10 includes, but is not limited to, a subject 12 providing the motion under analysis, objects 14 and 16 realizing the intended result of the motion under analysis, video cameras 18a and 18b that capture video data of the motion under analysis, a position data acquisition unit 20, motion sensors 22, a computer 24 and a display 26.

According to the embodiment of the invention shown in FIG. 1, the subject 12 providing the motion under analysis is an athlete. However, the subject 12 need not be an athlete or even a human being. For example, the subject 12 providing the motion under analysis may be any person engaging in a motion for which analysis is desired or may be a mechanical device such as an automobile, bicycle, skis, snowboard or any other mechanical device for which motion analysis is desired. In the embodiment of the invention shown in FIG. 1, the subject 12 providing the motion under analysis is a basketball player and the objects that realize the intended result of the motion are a basketball 14 and a basketball goal, or hoop, 16. In the embodiment of invention shown in FIG. 1, the subject 12 has taken a shot with the basketball 14 in an effort to put it through the hoop 16. As stated previously, however, although the embodiment of the invention shown in FIG. 1 utilizes a subject 12 who is a basketball player, a basketball 14 and a hoop 16, the subject 12 could be an athlete in any sport and the basketball 14 and hoop 16 could be other objects for realizing the intended result of the motion of the subject 12 as will be explained in greater detail below.

According to embodiments of the present invention, one or more video cameras may be used to record the motion of the subject 12 in video format. For example, in the embodiment of the invention shown in FIG. 1, two video cameras 18a and 18b are used to record the motion of the subject 12 in video format. While any number of video cameras 18a and 18b may be used to record video data of the subject 12, such as, for example, one, two, three or more video cameras, the embodiment of the invention shown in FIG. 1 uses two video cameras 18a and 18b to provide perspective and a three-dimensional view of the motion of the subject 12. The video cameras 18a and 18b may be any type of video camera, such as, for example, a stationary camera, a handheld camera, a digital camera, an analog camera and the like, that is capable of transferring its recorded data to the computer 24.

In addition to the video cameras 18a and 18b, the embodiment of the invention shown in FIG. 1 may include a position data acquisition unit 20 and one or more motion sensors 22. The position data acquisition unit 20 works in conjunction with the motion sensors 22 to capture position data of the subject 12 as the subject 12 moves. The position data acquisition unit 20 and the motion sensors 22 may take a variety of forms. For example, in the embodiment of the invention shown in FIG. 1, the motion sensors 22 are magnetic or electromagnetic motion sensors and the position data acquisition unit 20 is a data acquisition unit that responds to magnetic or electromagnetic sensors. However, the motion sensors 22 need not be magnetic or electromagnetic motion sensors. For example, the motion sensors 22 may be markers, such as ultraviolet, contrast or other type markers, RF tags, optical sensors, electronic sensors, mechanical sensors and the like. Likewise, the position data acquisition unit 20 can be any type of position data acquisition unit that works in conjunction with its associated sensors to provide one-dimensional, two-dimensional or three-dimensional position data of the subject 12.

According to an embodiment of the present invention, the motion sensors 22 and the position data acquisition unit 20 may interface with each other through a wireless or wired connection. For example, in the embodiment of the invention shown in FIG. 1, which uses magnetic or electromagnetic sensors, the communication link between the motion sensors 22 and the position data acquisition unit 20 is a wireless link. However, according to other embodiments of the present invention, the motion sensors 22 could be wired directly to the position data acquisition unit 20.

According to the embodiment of the invention shown in FIG. 1, the video cameras 18a and 18b and the position data acquisition unit 20 transfer the data they capture to the computer 24. The computer 24 in the embodiment of the invention shown in FIG. 1 may be a standard personal computer common in the art or may be a higher end workstation-type computer designed specifically for graphics processing and the like. The computer 24 includes, but is not limited to, an input device, an output device, a processor, memory and the like. In addition, the computer 24 may be connected to a display 26 to display the results of motion capture and analysis. Also, the computer may be part of a network, such as the Internet, for example. According to an embodiment of the present invention, data may be transferred and access to data may be available from a central server via a network.

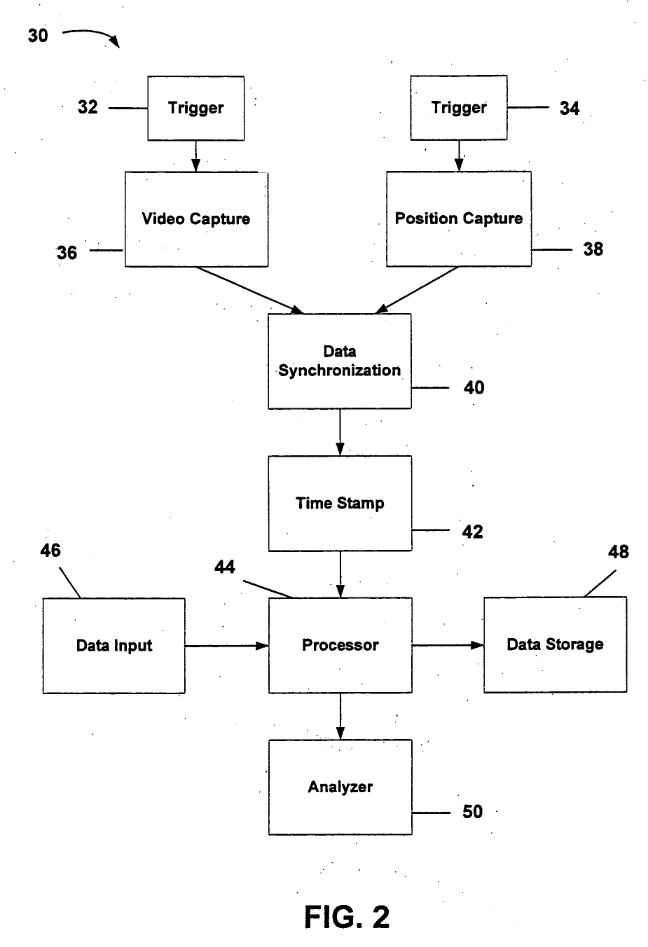

FIG. 2 shows a generalized system diagram for motion capture and analysis 30 according to an embodiment of the present invention. The embodiment of the invention shown in FIG. 2 includes, but is not limited to, a first trigger device 32, a second trigger device 34, a video capture unit 36, a position capture unit 38, a data synchronization unit 40, a time-stamp unit 42, a processor 44, a data input device 46, a data storage device 48 and a data analyzer 50.

The first trigger device 32 and the second trigger device 34 may be used to initiate data acquisition. For example, the first trigger device 32 and the second trigger device 34 may simply be a manual operator of the video capture equipment and the position capture equipment. Thus, the first trigger device 32 and the second trigger device 34 may be a person operating the video capture equipment or the position capture equipment. According to another embodiment of the present invention, the first trigger 32 and the second trigger 34 may be one of the motion sensors 22, referring to FIG. 1, that are positioned on the subject 12 providing the motion under analysis. Thus, when one of the motion sensors 22 detects motion by the subject 12, video capture and position capture is initiated.

Although the system diagram shown in FIG. 2 includes a first trigger device 32 and a second trigger device 34, embodiments of the present invention are not limited to two triggers. For example, a single trigger device may be used to initiate video capture and position capture. According to another embodiment of the present invention, a plurality of trigger devices may be used to initiate video capture and position capture. If a plurality of trigger devices are used to initiate video capture and/or position capture, the trigger devices may be used together such that video capture and/or position capture initiates only upon a combination of trigger events.

In addition, according to embodiments of the present invention, the trigger devices may be used to terminate data capture, such as, for example, video capture or position capture. For example, according to an embodiment of the present invention, when one of the motion sensors 22 detects the end of a motion by the subject 12, video capture and position capture may be terminated.

According to embodiments of the present invention, the video data captured in the video capture block 36 and the position data captured in the position capture block 38 are synchronized by the data synchronization block 40. Data synchronization may occur in a variety of ways. For example, referring to FIGS. 1 and 2, video data may be captured concurrently from the video cameras 18a and 18b and synchronized to a data stream from the position data acquisition unit 20 that captures position data via the motion sensors 22. The video data and the position data may be synchronized either by an external time code generator or by a time code generated by either the video cameras 18a and 18b or the position data acquisition unit 20. In addition, according to embodiments of the present invention, synchronization signals may be provided to the data capture equipment by a processor or other timing signal generating device located in the computer 24.

In addition to data synchronization, data captured by the video capture block 36 and the position capture block 38 may be time-stamped. The time-stamp block 42 may be implemented in a variety of ways. For example, according to embodiments of the present invention, the video cameras 18a and 18b may provide time-stamping as the video data is captured. Likewise, the position data captured by the motion sensors 22 and the position data acquisition unit 20 may be time-stamped by the position data acquisition unit 20 as it is captured. According to another embodiment of the present invention, the data captured by the data capture devices may be time-stamped by the computer 24.

Data that has been captured, synchronized and time-stamped may then be processed by the processor block 44. Data processing may include a variety of processing tasks as will be explained in greater detail below. Data processing may include, but is not limited to, data calculation such as calculation of velocity, acceleration, angular velocity and/or angular acceleration at any point of motion by the subject 12. In addition, data processing may include reconstruction of the motion of the subject 12 based on the captured data.

All captured data and all processed data may be stored in the data storage device 48. The data storage device may be any of a variety of storage devices such as, for example, memory such as RAM, hard drives, optical storage devices and the like.

In addition, data input block 46 provides for the input of various types of data into the processor 44. For example, a generally accepted ideal motion or “textbook” motion, the emulation of which is desired by the subject 12, may be input to the processor 44 by a user via a data input device. Thus, the ideal motion may define a standard against which the motion of the subject 12 may be compared. In addition, according to embodiments of the present invention, the data input block 46 may be used to define acceptable limits for the range of motion executed by the subject 12. Also, any data relating to the subject or object or the motion or any parameters affecting the motion may be entered as will be explained in greater detail below.

According to embodiments of the present invention, once data has been captured, synchronized, time stamped, processed and stored, and after data has been input by a user to define a standard motion or limits on the range of motion of a subject or parameters affecting the motion, all data may be analyzed at the analyzer block 50. Analysis of the data may include, but is not limited to, comparison of the motion under analysis to the standard motion and feedback to the subject 12 so that the subject 12 may modify his or her motion in an effort to improve the motion.

Although the generalized system diagram for motion capture and analysis 30 shown in FIG. 2 shows separate blocks for the data synchronization unit 40, the time-stamp unit 42, the processor 44 and the data analyzer 50, each of these elements may be implemented as individual elements, as a single element or as a combination of individual elements and a single element. For example, according to embodiments of the present invention, the data synchronization unit 40, the time-stamp unit 42 and the data analyzer 50 may be implemented by the processor 44, which may be part of the computer 24 shown in FIG. 1.

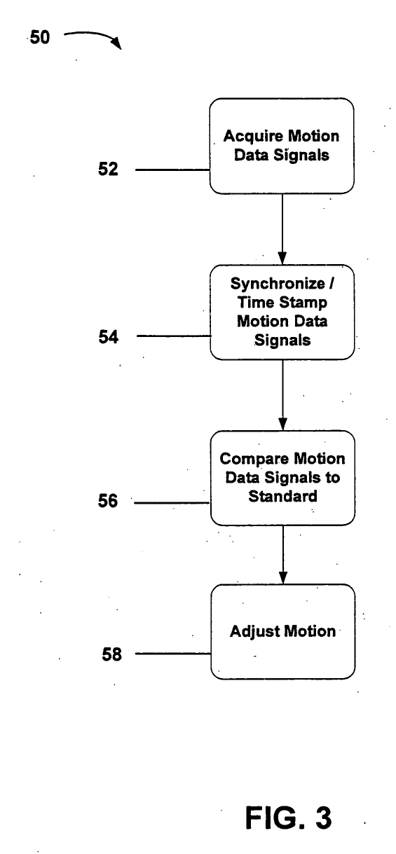

FIG. 3 shows a simplified flow chart 50 for capturing and analyzing a motion according to an embodiment of the present invention. At step 52, motion data signals are acquired. The motion data signals may represent the motion of a subject. At step 54, the motion data signals are synchronized and time stamped. At step 56, the motion data signals are compared to a standard or ideal motion. At step 58, the motion of a subject is adjusted based on the comparison of the motion data signals to the standard motion.

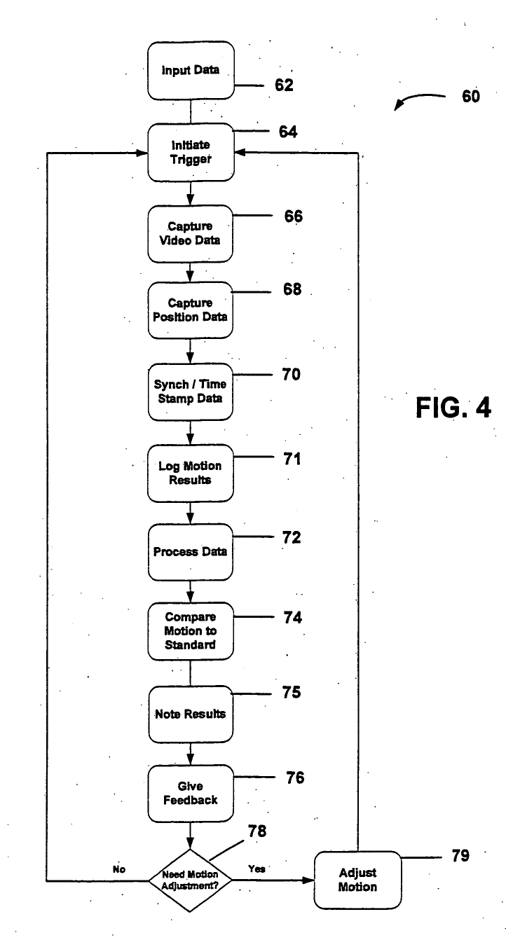

FIG. 4 shows a detailed flow chart 60 of a method for capturing and analyzing motion data according to an embodiment of the present invention. According to embodiments of the present invention, a variety of data may be entered into the system at step 62. For example, according to an embodiment of the present invention, the data entered into the system may be related to the motion of the subject or object. The data entered into the system may be related to an ideal motion or motion defining a “standard” motion or, according to another embodiment of the present invention, the data entered into the system may be related in a more general way to the type of motion made by the subject or object, or to anything affecting the type of motion made by the subject or object, such as external forces, for example, as will be explained below.

According to an embodiment of the present invention, the data entered into the system may be related to an ideal motion or motion defining a “standard” motion. For example, for a basketball player taking a free throw, an ideal or standard motion may be defined by “standard” free throw form. A system user may enter into the system data defining a “standard” free throw. Such data may include, but is not limited to, the angle of the player's forearm to the player's upper arm, the angular velocity of the player's shoulders, the player's wrist position at the beginning of the shot, the player's wrist position at release and the like.

The “standard” motion data may be entered into the system in a variety of ways. For example, according to an embodiment of the present invention, a playing area, such as a basketball court, for example, may be defined by a three-dimensional coordinate system and standard movement of the subject may be defined in terms of the three-dimensional coordinates. Thus, a reference point may be defined in the three-dimensional coordinate system and all positions and angles may be defined in terms of the reference point. According to another embodiment of the present invention, the basketball court, for example, may be defined by a polar coordinate system and standard movement of the subject may be defined in terms of the polar coordinates.

As an example, if the standard motion for a basketball player shooting a free throw is desired, the angle of the player's forearm with respect to the player's upper arm and the angle of the player's upper arm with respect to the floor may be entered into the system, using the floor as a reference point of zero degrees. As another example, the position of the player's feet relative to the free throw line may be entered into the system, using the free throw line as either the x- or y-axis of a coordinate system.

According to an embodiment of the present invention, general information regarding the motion of the subject or event-specific variables regarding the motion of the subject or the subject itself or anything affecting the type of motion made by the subject or object may be entered into the system. For example, the system may accept data such as, but not limited to, the position of a player, the physical characteristics of a player, such as height or weight, and data related to the nature of the motion. For example, if the motion under analysis is provided by a basketball player, the type of shot may be entered into the system. For example, the type of shot might be defined as a free throw, a college 3-pointer, an NBA 3-pointer or a jump shot. As another example, if the motion under analysis is provided by a volleyball player, the motion could be entered into the system as an outside hitter down the line, an outside hitter cross-court, an inside hitter cross-court and the like.

According to an embodiment of the present invention, data and/or variables related to anything affecting the type of motion made by the subject or object may be entered into the system as well. For example, if the subject providing the motion is a football kicker, information related to the position of the football on the field, such as at the left or right hash mark, wind speed, wind direction, temperature, distance to the goalpost and the like may be entered into the system. Data of this nature may be manually entered into the system or may be automatically entered into the system using sensors for capturing this kind of data. If the sensors for capturing this type of data are used, the data captured by these sensors may be synchronized and time-stamped along with other data captured by the system.

According to an embodiment of the present invention, once all desired data has been entered into the system, a trigger event may be initiated at step 64. Trigger events may be initiated in a variety of ways. For example, according to an embodiment of the present invention, the system may be running continuously, capturing data continuously, while the subject or object is in motion, and a trigger event indicating a start time or stop time of the motion under analysis may be entered manually. For example, once enough data has been captured, a video frame in which a shot begins may be marked as a trigger event and a video frame in which a shot ends may be marked as a trigger event. According to another embodiment of the present invention, trigger events may be initiated automatically. For example, if a motion sensor is placed on a finger of a subject, such as a basketball player for example, a trigger event may be indicated when the motion sensor detects a release of the basketball from the player's hand. According to another embodiment of the present invention, if the subject providing the motion under analysis is a football player, for example, optical sensors may be utilized to indicate the placement or kicking of a football, thereby initiating a triggering event for data capture.

Once a trigger event has been initiated, video data may be captured at step 66 and position data may be captured at step 68. Although position data capture at step 68 follows video data capture at step 66 in FIG. 4, the order of these events may vary. For example, position data capture may precede video data capture or, according to another embodiment of the present invention, position data capture and video data capture may commence and end simultaneously.

Referring now to FIGS. 1 and 4, video data capture may be implemented in a variety of ways. The video cameras 18a and 18b may be positioned anywhere within the area defined by the coordinate system in which the motion under analysis is taking place. The location of the video cameras 18a and 18b may be determined by the user in accordance with the user's needs. The video cameras 18a and 18b may be positioned to capture a general motion of the subject or object 12 or a specific motion of the subject or object 12. For example, if the subject 12 providing the motion under analysis is a basketball player, the video cameras 18a and 18b may be positioned in such a way so as to capture the general movement of the basketball player as he or she is driving to the basket to execute a lay-up. In this configuration, the video cameras 18a and 18b may capture in video format the general position of the player's body with respect to the basketball 14 and the hoop 16.

According to another embodiment of the present invention, the video cameras 18a and 18b may be positioned to focus in on a specific element of the motion of the subject 12. For example, if the subject 12 providing the motion under analysis is a basketball player, the video cameras 18a and 18b may be positioned and focused specifically on the wrist of the shooting hand of the player to capture the wrist motion of the player as he or she is taking a shot.

According to embodiments of the present invention, position data capture at step 68 may be accomplished in a variety of ways. For example, the motion sensors 22 may be positioned on a subject 12 and used in conjunction with the position data acquisition unit 20 to capture position data of the subject 12 providing the motion under analysis. According to an embodiment of the present invention, the motion sensors 22 may be placed on the subject 12 providing the motion under analysis so as to reconstruct the motion of the subject 12 over a particular time segment of interest. The motion sensors 22 may be positioned to allow for comparison of the motion of the subject 12 to a particular target of interest, such as, for example, a basketball hoop, goalpost, a landing area/court and the like.

The time segment of interest may vary depending on the particular activity engaged in by the subject 12 providing the motion under analysis. For example, if the subject 12 providing the motion under analysis is a basketball player, the time segment of interest might be at the beginning of a shot to post-release follow-through. As another example, if the subject 12 providing the motion under analysis is a volleyball player, the motion under analysis may be a volleyball spike and, consequently, the time segment of interest may include a run-up, a jump, an arm movement and a follow-through. Similarly, if the motion under analysis is the kicking of a field goal in football, the time segment of interest may begin at the point where the kicker lines up in relation to the ball, to run up and follow-through.

The actual placement of the motion sensors 22 on to the subject 12 may be implemented in a variety of ways. For example, the motion sensors 22 may be positioned on a primary limb involved in the motion under analysis and on ancillary body parts that contribute significantly to the motion under analysis. According to an embodiment of the invention, if the subject 12 providing the motion under analysis is a football player kicking a football, the motion sensors 22 may be positioned on the football player's kicking leg, the football player's off leg, the football player's waist and the football player's shoulders. According to another embodiment of the present invention, if the subject 12 providing the motion under analysis is a basketball player, motion sensors 22 may be positioned at multiple locations on the player's shooting arm, such as, for example, the index finger at the knuckle, the wrist and the elbow, on both shoulders on the small of the back even with the hip joint, on both knees and on both ankles. According to this embodiment of the invention, positioning the motion sensors 22 in this way may facilitate reconstruction of the human form during motion when the results of the data capture are analyzed.

After data has been captured, the data may be synchronized and time-stamped at step 70 to facilitate processing and analysis. Also, the results of the motion under analysis may be logged at step 71. For example, the motion under analysis may have an intended result. Referring to FIG. 1, if the subject 12 providing the motion under analysis is a basketball player shooting a free throw, for example, the intended result is to pass the basketball 14 through the hoop 16. After completing the motion under analysis, the results of the motion may be recorded. Thus, in the example, after the basketball player shoots the free throw, the results of the free throw shot may be recorded, i.e., whether or not the shot was made.

In addition, the level of success of the motion under analysis may also be logged or recorded. For example, for a basketball player taking a shot, the varying levels of success may include, without limitation, a swish, a hit rim, multiple hits (e.g., rim and backboard or multiple hit rims) or miss. For a volleyball player spiking a volleyball, for example, the varying levels of success may include, without limitation, a clean shot (no net, inbounds), a net shot (inbounds), an out of bounds shot or a net and out of bounds shot. For a football player kicking a field goal, for example, the varying levels of success may include, without limitation, a kick down the center of the goalpost, inside the right upright, inside the left upright, or short of the goalpost.

After the results of the motion under analysis have been logged, all data in the system may be processed and stored at step 72. Data processing may include a variety of tasks. For example, according to an embodiment of the present invention, a series of time-stamped, synchronized data may be used to calculate a velocity, an angular velocity, an acceleration, an angular acceleration or other parameter associated with any sensed point on the subject 12 providing the motion under analysis.

Also, according to an embodiment of the present invention, data processing may include processing captured data to reconstruct the human form of the subject 12 providing the motion under analysis. For example, by placing seven sensors or sensor pairs at the following points on the body of a subject 12: sensor 1—index finger at knuckle; sensor 2—wrist; sensor 3—elbow; sensors 4—both shoulders; sensor 5—small of the back even with hip joint; sensors 6—both knees; and sensors 7—both ankles, data received from the following sensors or sensor pairs may be used to reconstruct the body of the subject 12: 1) sensor 1 to sensor 2=hand; 2) sensor 2 to sensor 3=forearm; 3) sensor 3 to sensors 4=upper arm; sensors 4 to a stationary point=rotation of upper body; sensors 4 to sensor 5=torso; sensor 5 to sensors 6=thigh; sensors 6 to sensors 7=shank. Thus, many areas of interest of the human form of the subject 12 may be reconstructed, thereby facilitating analysis of the motion. In addition, the angle of a body segment for any given point in time may be determined by the arc tangent of the position of the upper body fulcrum over the lower body fulcrum.

Data processing may also include a variety of other tasks. For example, depending on the data captured or received by the system, parameters such as wind speed, wind direction, temperature and the like may be calculated and/or processed along with other data.

According to an embodiment of the present invention, data processing may also include defining the “best form” of the subject 12. The “best form” of the subject 12 may represent a profile of the subject 12 when the motion of the subject 12 results in the intended result of the motion. The “best form” of the subject 12 may be defined by compiling motion data in connection with the result or level of success of the motion. For example, the processor 44 may calculate a statistical regression of the motion data against the results logged to determine the “best form” of the player. A stepwise regression may be used for data sets that are computationally prohibitive for real-time analysis.

For example, if the subject 12 providing the motion under analysis is a basketball player, by performing a statistical regression or other mathematical operation on the data captured for the player, a profile may be generated of certain key predictors for all shots taken by the player that are made. Also, other predictors for a additional results, such as, for example, all shots made, whether clean or not, or all jump shots made between twelve and fifteen feet of the basket, may also be generated. Other parameters, like statistical parameters, such as distribution and standard deviation, for example, related to the captured data may also be calculated by the processor. Accordingly, an entire profile of the subject 12 providing the motion under analysis may be generated to define a “best form” of the subject 12.

At step 74, captured data representing the motion under analysis may be compared to a standard. For example, if the subject 12 providing the motion under analysis is a basketball player, a particular shot taken by the player may be compared against the “best form” of the player for that particular shot, an ideal or “textbook” form that has been previously defined for that particular shot, or both. Also, according to an embodiment of the present invention, data processing may include a determination of whether the data captured for the particular shot falls within or outside of an acceptable range defined by the standard against which the shot is measured (e.g., the “best form” of the player or the “textbook” form). Data points that deviate too far from the standard may also be identified.

According to embodiments of the present invention, data comparison at step 74 may be included with or distinct from data processing at step 72. For example, data comparison may include an automatic comparison of the data performed by a processor. According to another embodiment of the present invention, captured and processed data may be displayed on a computer screen or other display device and compared manually by the player, a coach or other person.

Also, at step 75, the results of the motion are noted. A determination may be made as to whether the results of the motion under analysis were acceptable. The determination at step 75 may be a part of or may be distinct from the comparison at step 74. Feedback may be given to the subject 12 at step 76 in a variety of ways based on the captured data and the results of the motion. For example, if the subject 12 providing the motion under analysis is a basketball player taking a particular shot, the shot may be charted on a visual display against a standard, such as, for example, a “best form” of the player or a “textbook” form, on a parameter-by-parameter basis. For example, the visual display may show parameters such as, for example, release velocity, forearm/upper arm minimum angle, release point and the like. In addition, the display may give a visual representation of where data related to the shot falls out of an acceptable range.

According to an embodiment of the present invention, feedback may be initiated by selecting visually displayed positional data points. The selected data points may be linked to a particular video frame to which the data points have been synchronized and time-stamped. The video frame or frames at the data points of interest may then be played back to the subject 12 for analysis. In addition, visual references may be incorporated into the video frames showing which sensors or measurements may have fallen out of an acceptable range. For example, the visual reference may include a symbol for a “wrist” of the subject 12, in the case of a basketball player taking a shot, for example, and an arrow showing where the player's wrist should have been relative to where it was when the shot was taken. In addition, the visual reference may also be linked to positional data points so that selecting a visual reference on a display produces a correlated data chart.

Thus, if the motion under analysis falls outside of an acceptable range of motion, which may be determined, for example, by comparing the motion under analysis to a standard such as a “textbook” motion or the best motion for the player, for example, the visual data may be viewed in relation to the positional data as part of the analysis of the motion. In other words, because, according to embodiments of the present invention, video data may be synchronized to positional data and because motion analysis may be linked to a range of motion, when a player executes a motion that falls outside of an acceptable range of motion, the motion falling outside of the acceptable range may be analyzed in comparison to a standard motion defining the acceptable range of motion.

According to an embodiment of the present invention, feedback may be aural. For example, if a basketball player takes a shot and the shot motion deviates from a standard shot motion, an aural feedback such as, “Your release was faster than ideal” or “Your wrist moved from left to right at release” or “Your elbow was bent at 45 degrees during the shot” may be given to the player.

If the results of the motion under analysis were acceptable, such as, for example, a basketball player made the shot he or she attempted, the player may, according to an embodiment of the present invention, continue to execute the motion under analysis or analyze the captured data to determine why the particular motion generated an acceptable result. If desired, the player may determine that a “fine tuning” or an adjustment of the motion is necessary at step 78. The motion may then be adjusted at step 79.

If the results of the motion under analysis were not acceptable, such as, for example, a basketball player did not make the shot he or she attempted, the player may, according to an embodiment of the present invention, the player may again determine that an adjustment of the motion is necessary. The motion may then be adjusted at step 79.

According to an embodiment of the present invention, adjustment of the motion may include querying the system via a query engine to solicit suggestions on improving the motion. For example, using statistics calculated or received during processing at step 72, a basketball player may query the system in a manner to determine changes in the player's motion that will increase the success level of the results of the motion. Thus, a basketball player may ask, for example, “What does the player have to change when fading away to improve the chances for success?” The processor may perform a statistical calculation on data representing successful shots where the player's shoulder velocity is negative in a particular plane at release as compared to other successful shots and identify parameter differences between the two motions. The player may then use the results of the calculation to adjust his or her motion.

Other types of queries may also be included. For example, a basketball player may query “What is the most significant shooting error by players taller than a specific height?” The processor may then perform a statistical calculation on data representing missed shots against data representing made shots for players taller than the specific height.

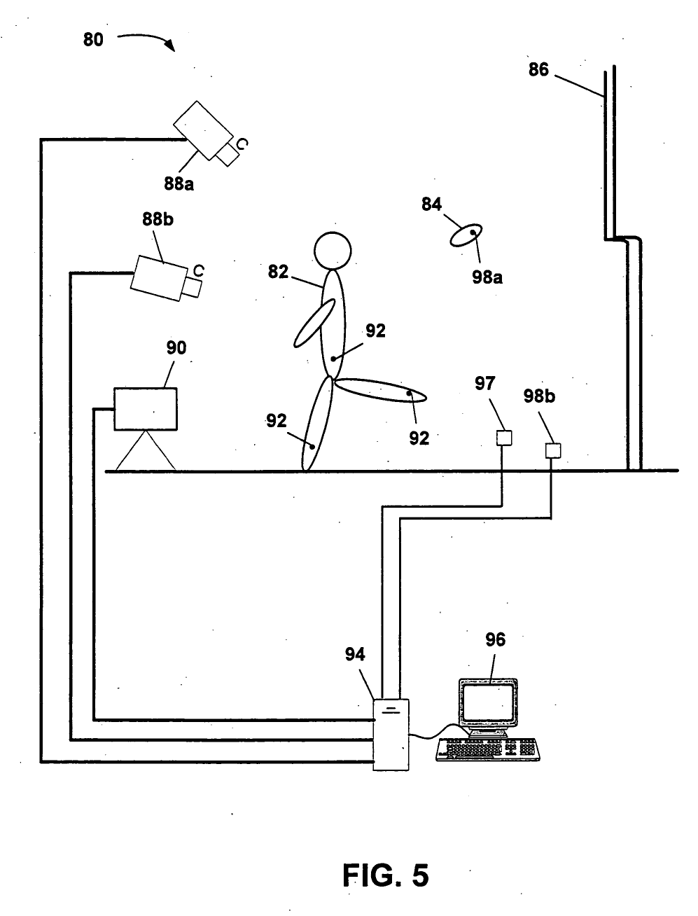

Although many examples discussed up to this point have made use of a basketball player executing a shot as is shown in FIG. 1, the system and method of according to embodiments of the present invention may be employed in a variety of contexts. For example, FIG. 5 shows a generalized schematic diagram of a system for motion capture and analysis 80 according to an embodiment of the present invention. In FIG. 5, the system for motion capture and analysis 80 includes, but is not limited to, a subject 82 providing the motion under analysis, objects 84 and 86 realizing the intended result of the motion under analysis, video cameras 88a and 88b that capture video data of the motion under analysis, a position data acquisition unit 90, motion sensors 92, a computer 94 and a display 96. In the embodiment of the invention shown in FIG. 5, the subject 82 providing the motion under analysis is a football kicker kicking a field goal and the objects 84 and 86 realizing the intended result of the motion under analysis are a football and goalpost, respectively.

FIG. 5 also shows an environment sensor 97 and a device sensor 98a along with its associated data acquisition unit 98b. The environment sensor 97 may be used to sense environmental parameters, such as, for example, wind speed, wind direction, temperature, distance to the goalpost and the like. The output of the environment sensor 97 may be input to the computer 94 and used for calculations and when evaluating the motion under analysis. The device sensor 98a in FIG. 5 is attached to the object 84, in this case a football, and can measure various mechanical components associated with the football. For example, the device sensor may measure the velocity, either linear or angular, of the football. In other embodiments of the present invention, the device sensor 98a may measure a variety of mechanical or electrical parameters associated with a mechanical or other device. For example, if a device sensor is placed on a wheel of a vehicle providing the motion under analysis, the device sensor may measure torque, temperature, angular velocity and the like. Also, the device sensor 98a and its associated data acquisition unit 98b may be a wired or wireless device.

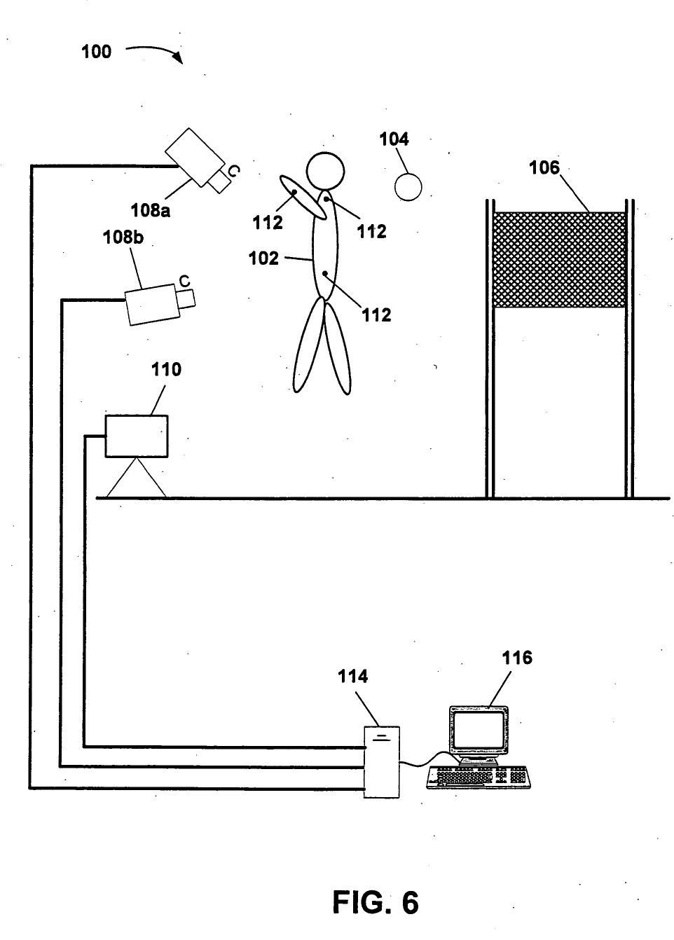

Similarly, FIG. 6 shows a generalized schematic diagram of a system for motion capture and analysis 100 according to an embodiment of the present invention. In FIG. 6, the system for motion capture and analysis 100 includes, but is not limited to, a subject 102 providing the motion under analysis, objects 104 and 106 realizing the intended result of the motion under analysis, video cameras 108a and 108b that capture video data of the motion under analysis, a position data acquisition unit 110, motion sensors 112, a computer 114 and a display 116. In the embodiment of the invention shown in FIG. 6, the subject 102 providing the motion under analysis is a volleyball player spiking a volleyball and the objects 104 and 106 realizing the intended result of the motion under analysis are a volleyball and net, respectively.

While particular embodiments of the present invention have been shown and described, it will be obvious to those skilled in the art that the invention is not limited to the particular embodiments shown and described and that changes and modifications may be made without departing from the spirit and scope of the appended claims.

1. A method for capturing and analyzing motion comprising:
defining a standard motion;
receiving a first signal from a first sensor, the first signal being representative of a motion under analysis;
receiving a second signal from a second sensor, the second signal being representative of the motion under analysis;
synchronizing the first signal to the second signal; and
comparing the motion under analysis represented by the synchronized first signal and second signal to the standard motion.

2. The method of claim 1, wherein comparing the motion under analysis includes identifying when the motion under analysis falls outside of an acceptable range of motion in relation to the standard motion.

3. The method of claim 1, further comprising adjusting the motion under analysis based on the comparison of the synchronized first signal and second signal to the standard motion.

4. The method of claim 1, further comprising logging an intended result of the motion under analysis.

5. The method of claim 4, further comprising adjusting the motion under analysis based on the comparison of the synchronized first signal and second signal to the intended result of the motion under analysis.

6. The method of claim 1, further comprising initiating a trigger event to begin receiving the first signal.

7. The method of claim 1, further comprising initiating a trigger event to terminate reception of the first signal.

8. The method of claim 1, further comprising initiating a trigger event to begin receiving the second signal.

9. The method of claim 1, further comprising initiating a trigger event to terminate reception of the second signal.

10. The method of claim 1, further comprising time-stamping the first signal.

11. The method of claim 1, further comprising time-stamping the second signal.

12. The method of claim 2, wherein the first signal is a video signal.

13. The method of claim 12, wherein the second signal represents position information.

14. The method of claim 13, further comprising reconstructing the motion under analysis using the position information.

15. The method of claim 14, further comprising comparing the reconstructed motion to the standard motion.

16. The method of claim 1, further comprising generating a composite display of the first signal and the second signal.

17. The method of claim 14, further comprising generating a composite display of the video signal and the reconstructed motion under analysis.

18. The method of claim 17, further comprising analyzing the video signal in relation to the position information when the motion under analysis falls outside of the acceptable range of motion.

19. The method of claim 1, wherein the standard motion is a generally accepted ideal motion for the motion under analysis.

20. The method of claim 1, wherein the standard motion is an ideal motion for a subject executing the motion under analysis.

21. The method of claim 1, wherein the standard motion is defined by a user.

22. The method of claim 12, further comprising receiving the video signal from a video camera.

23. The method of claim 22, further comprising focusing the video camera on a subject providing the motion under analysis.

24. The method of claim 13, further comprising positioning sensors for capturing the position information on a subject providing the motion under analysis.

25. The method of claim 1, further comprising receiving a third signal from a third sensor, the third signal being representative of environmental data;
synchronizing the third signal to the first signal and the second signal; and
analyzing the motion under analysis represented by the synchronized first signal and second signal in relation to the third signal.

26. The method of claim 1, further comprising receiving a fourth signal from a fourth sensor, the fourth signal being representative of a mechanical or electrical parameter;
synchronizing the fourth signal to the first signal and the second signal; and
analyzing the motion under analysis represented by the synchronized first signal and second signal in relation to the fourth signal.

27. The method of claim 2, further comprising providing visual feedback when the motion under analysis falls outside the acceptable range of motion.

28. The method of claim 2, further comprising providing audio feedback when the motion under analysis falls outside the acceptable range of motion.

29. The method of claim 1, further comprising accepting a query from a user when comparing the motion under analysis represented by the synchronized first signal and second signal to the standard motion.

30. The method of claim 24, wherein the sensors are magnetic sensors.

31. The method of claim 24, wherein the sensors are optical sensors.

32. The method of claim 1, wherein receiving the first signal and receiving the second signal comprise receiving the first signal and the second signal over a network.

33. The method of claim 32, wherein the network is the Internet.

34. A system for capturing and analyzing motion comprising:
an input device for receiving data defining a standard motion;
a first sensing device for generating a first signal representative of a motion under analysis;
a second sensing device for generating a second signal representative of the motion under analysis;
a synchronizer for synchronizing the first signal to the second signal; and
a processor for comparing the motion under analysis represented by the synchronized first signal and second signal to the data defining the standard motion.

35. The system of claim 34, wherein the input device receives data representing an intended result of the motion under analysis.

36. The system of claim 35, wherein the processor is configured to evaluate the motion under analysis in light of the intended result of the motion under analysis.

37. The system of claim 24, further comprising a first trigger mechanism for initiating generation of the first signal.

38. The system of claim 24, further comprising a second trigger mechanism for initiating generation of the second signal.

39. The system of claim 24, further comprising a time-stamper for time-stamping the first signal.

40. The system of claim 24, further comprising a time-stamper for time-stamping the second signal.

41. The system of claim 24, wherein the first sensing device is a video camera.

42. The system of claim 24, wherein the first signal is a video signal.

43. The system of claim 24, wherein the second sensing device is a motion sensor.

44. The system of claim 43, wherein the second signal represents position information.

45. The system of claim 43, wherein the motion sensor is a magnetic sensor.

46. The system of claim 43, wherein the motion sensor is an optical sensor.

47. A system for capturing and analyzing motion comprising:
means for defining a standard motion;
means for receiving a first signal from a first sensor, the first signal being representative of a motion under analysis;
means for receiving a second signal from a second sensor, the second signal being representative of the motion under analysis;
means for synchronizing the first signal to the second signal; and
means for comparing the motion under analysis represented by the synchronized first signal and second signal to the standard motion.

48. The system of claim 47, further comprising means for adjusting the motion under analysis based on the comparison of the synchronized first signal and second signal to the standard motion.

49. The system of claim 47, further comprising means for time-stamping the first signal and the second signal.

50. The system of claim 47, wherein the second signal represents position information.

51. The system of claim 50, further comprising means for reconstructing the motion under analysis using the position information.

52. The system of claim 51, wherein the processor is configured to compare the reconstructed motion to the standard motion.

53. The system of claim 47, further comprising a processor for generating a composite display of the first signal and the second signal.

54. The system of claim 51, further comprising a processor for generating a composite display signal of the video signal and the reconstructed motion under analysis.

55. The system of claim 54, further comprising a display for displaying the composite display signal of the video signal and the reconstructed motion under analysis.
